(19) United States
(12) Patent Application Publication
(10) Pub. No.: US 2007/0048201 A1
(43) Pub. Date: Mar. 1, 2007

(54) Oxygen generation system and method

(75) Inventor: John E. Sagaser, Boise, ID (US)

Correspondence Address: ROBERT L. SHAVER;DYKAS, SHAVER & NIPPER, PO BOX 877, BOISE, ID, 83701-0877, US

(73) Assignee: Ox-Gen, Inc., Boise, ID (US)

(21) Appl. No.: 11/312,091

(22) Filed: Dec. 20, 2005

Related U.S. Application Data
(60) Provisional application No. 60/711,195, filed on Aug. 24, 2005.

(51) Int. Cl. B01J 8/04; B01J 19/00

(52) U.S. Cl. 422/190; 422/198

(57) ABSTRACT

An oxygen generation system is provided which uses three chambers each containing a chemical for generating oxygen. Two catalyst chambers are provided with different catalyst exposure and dispersion modes.

### CROSS-REFERENCE TO RELATED APPLICATIONS

This application is a non-provisional application which claims the priority date from the provisional application entitled RIGID O₂ GENERATION SYSTEM MODEL 5-OX-03 filed by John E. Sagaser on Aug. 24, 2005 with application Ser. No. 60/711,195, the disclosure of which is incorporated herein by reference.

### FIELD OF THE INVENTION

The invention generally relates to an apparatus and method for producing oxygen, and more particularly to a portable oxygen generator in a rigid case.

### BACKGROUND OF THE INVENTION

There are a number of situations in which a source of oxygen would be an essential lifesaving tool. This could include a situation where a person is in a burning building and a supply of oxygen, even if only for a few minutes, would increase his or her chances of escape from the smoke filled building. This could apply to office workers, rescue personnel or police.

Another situation in which emergency oxygen would be useful is in response to an emergency situation, such as an environment filled with poisonous gases. This could occur in a chemical plant from a rupture of a tank, or could occur on a battlefield from the use of chemical weapons. In such a case, having a quickly available supply of oxygen, which has been conveniently stored and has a long shelf life, would be a lifesaver. Other situations in which an emergency supply of oxygen would be useful would include use by pilots who may need to dear their head when flying at a higher elevation, first-aid situations in which oxygen may need to be administered in the field before the person is picked up by oxygen equipped rescue personnel, at home where a person may wish to administer oxygen in response to shortness of breath, heart arrhythmia, heart attack or stroke.

The prior art includes many oxygen generation devices. Many of them involve a rigid canister in which oxygen gas is compressed, and from which it can be released for breathing. Other prior art oxygen generation systems are reaction vessels, in which chemicals of various types can be added in order to set up a reaction that generates oxygen. The problem with compressed oxygen is that these systems are expensive, heavy and not practical for most people to have on hand or for field situations. Devices based on a reaction vessel are impractical if the reaction vessel is bulky and hard to carry, and if the chemicals take any more than the absolute minimum of time and effort to add and mix for use. A person cannot hold their breath very long while preparing such a canister, measuring ingredients, and adding the ingredients. A reaction vessel which takes more than ten (10) seconds to access, activate, and begin receiving oxygen is not very effective. One that takes several minutes to access, activate and begin receiving oxygen is not particularly practical in the situations that are described above.

A portable emergency oxygen generation system needs to be small in size, have a long shelf life, be easy to activate, but which does not activate accidentally, and must generate breathable oxygen within a few seconds of activation. Anything that takes more than even five seconds is not effective in certain situations. It must also generate a sufficient volume of oxygen for a sufficient amount of time to be useful. None of the prior art oxygen generation devices has these features.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

These and other features are found in the oxygen generation system of the invention. The oxygen generation system of the invention includes a canister body. The canister body includes a first reaction chamber and a second reaction chamber. A first reactant is contained in the first reaction chamber and a second reactant is contained in the second reaction chamber. The two reactants are selected for their oxygen generation capacity when mixed together. A valve is present between the first and second reaction chambers and the canister is configured so that the second reactant can flow into the first reactant when the valve between them is opened. The canister also contains a first catalyst chamber in which a quantity of first catalyst is isolated. There is also present a second catalyst chamber which is located inside the first reaction chamber in which a second catalyst is isolated. The second catalyst is isolated from the first reactant in the first reaction chamber.

Also provided is an escape route or exit pathway for oxygen which is generated in the first reaction chamber. Another part of the system is an oxygen delivery system which is operatively connected to the oxygen pathway and connects the oxygen delivery canister body to a user, for the purpose of delivering oxygen to the user.

The oxygen generation starts when the valve between the first and second chambers is opened and the second reactant flows into the first chamber and mixes with the first reactant. The flow of the second reactant causes a good deal of mixing with the first catalyst and the second reactant. The first reactant is in the first reaction chamber and the second catalyst is located in the second catalyst chamber which is within the first reaction chamber. The resultant reaction is one which produces a steady flow of oxygen for a selected period of time. The percentage of oxygen produced is above a certain minimum for the entire selected period of time.

Chemicals which combine to cause the release of oxygen are well known in the art, and so are catalysts that facilitate the oxygen generation reaction. The reactants and catalysts can be selected from any number of known oxygen generating reactants. The first and second catalyst can be two different materials for instance. The first and second catalyst can also each contain more than one particular chemical, and both can be made up of the same chemical or mix of chemicals.

In one embodiment of the invention, the valve between the first and second chambers is a plunger-type valve. This is a type of valve which is basically a plate or a disk which is pressed against a sealing member such as O rings in order to seal an opening. When the plate or a disk is moved away from the sealing contact with the sealing member, the passageway is opened between the two chambers and liquid in the upper chamber flows freely around the plate or disk of the plunger-type valve and into the first reaction chamber below. In one embodiment of the invention, the first catalyst chamber is opened when the plunger valve between the two chambers is opened. As the second reactant from the second reaction chamber flows into the first reaction chamber, the material of the first catalyst is swept into the first reaction chamber and disperses the second reactant and the first reactant. One way in which this is accomplished is to have the disk or plate of the plunger valve form one side of the first catalyst chamber. When the plunger valve is opened, material of the first catalyst is thus exposed to the flow of the second reactant and is swept into the first reaction chamber.

The device also includes a second catalyst chamber which is located in the first reaction chamber. The second catalyst chamber isolates a quantity of second catalyst, which may be one or more chemicals and which may be the same or different chemicals as the first catalyst. The material in the second catalyst chamber is isolated from this first and second reactant, until the user opens the second catalyst chamber to expose it. Mixing would occur when the second reactant flows into the first reaction chamber and mixes with the first reactant. The second catalyst chamber may be exposed by turning a shaft which extends to the outside of the canister and which is actuated by a knob or dial on the outside of the canister.

The oxygen generation canister may also include a third reaction chamber containing a coolant. When a third reaction chamber is utilized, a passage is provided between the third reaction chamber and the oxygen being generated. The coolant in the third reaction chamber may be water or another liquid. In one version there is provided a valve between the second and third reaction chambers which is part of the oxygen escape pathway. Oxygen is generated in the first reaction chamber, passes by the plunger valve into the second reaction chamber, and through the escape valve and into the third reaction chamber where it bubbles through the water or other coolant. After bubbling through the water or other coolant in the third reaction chamber, the oxygen which has been generated exits the canister via the delivery system which would typically be a hose and a face mask or nasal canula or the equivalent.

The second catalyst chamber can be configured so that when the second reactant is added to the first reaction chamber, the opening of the second catalyst chamber is lower than the level of the liquid in the first reaction chamber, and the second catalyst may thus float out into the liquid of the second reactant.

One embodiment of the invention includes three knobs or dials on the outside of the canister body which are utilized to activate in sequence the oxygen generation process which takes place inside the canister. One knob is to expose the second catalyst in the first reaction chamber. A second knob is to release the second reactant into the first reaction chamber and thus, begins the oxygen generation reaction. The third knob is to open the escape valve between the second and third reaction chambers to allow oxygen to pass from the second reaction chamber into the third reaction chamber and to exit the canister into the oxygen delivery system.

The third reaction chamber may be configured so that a generally J-shaped or U-shaped tube is present and attached to the escape valve between the second and third reaction chambers. Oxygen which passes through the escape valve then passes through the J-shaped tube and is released into the cooling liquid or water of the third reaction chamber. It bubbles through the water which helps to cool the oxygen from the exothermic reaction, and also serves to scrub unwanted byproducts of the reaction from the gas exiting the canister.

The invention is also a method by which the above canister is configured to generate oxygen.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention, which is measured by the claims, nor is it intended to be limiting as to the scope of the invention in any way.

Still other features and advantages of the present invention will become readily apparent to those skilled in this art from the following detailed description describing only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a cross-sectional view of the oxygen generation system of the invention.

FIG. 2 is a perspective view of the oxygen generation system of the invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific forms disclosed, but, on the contrary, the invention is to cover all modifications, alternative constructions, and equivalents falling within the spirit and scope of the invention as defined in the claims.

The oxygen generation system of the invention is a device that delivers 6 or more liters per minute of 99% pure oxygen for at least a 15 minute interval. This is achieved by means of a chemical reaction that occurs when the generator is activated.

A preferred version of the device is a three chambered unit constructed out of any number of suitable plastic materials. The three chambers are connected by valves. Pre-measured chemicals are contained within these chambers in order to generate instant, non-pressurized oxygen on demand. Three valves are opened sequentially enabling the chemicals to mix, react, and deliver the oxygen to the facemask tubing. The three valves provide a simple, foolproof and fast way to initiate oxygen generation.

The generator unit may be placed in an insulated carrying case/storage bag for convenience and protection.

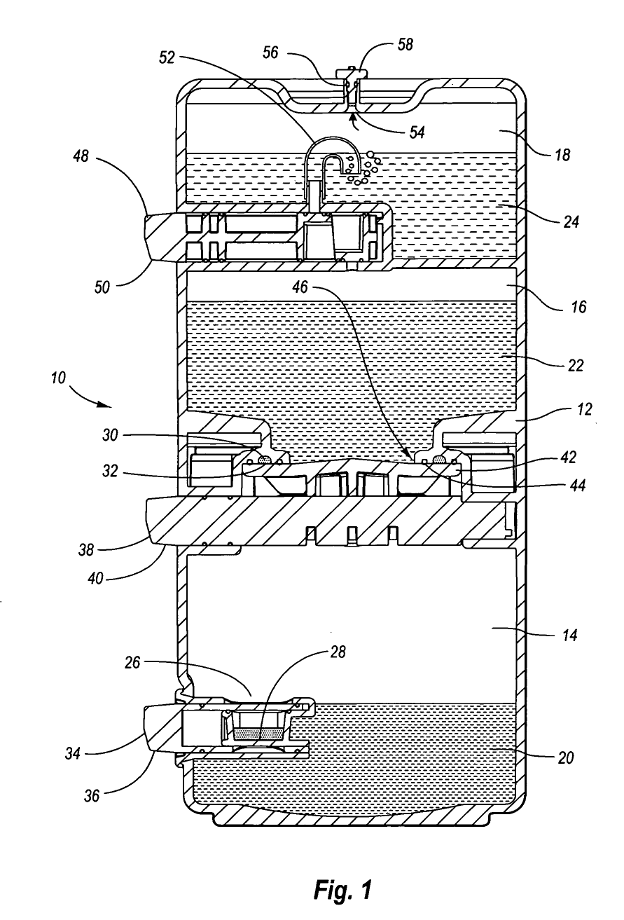

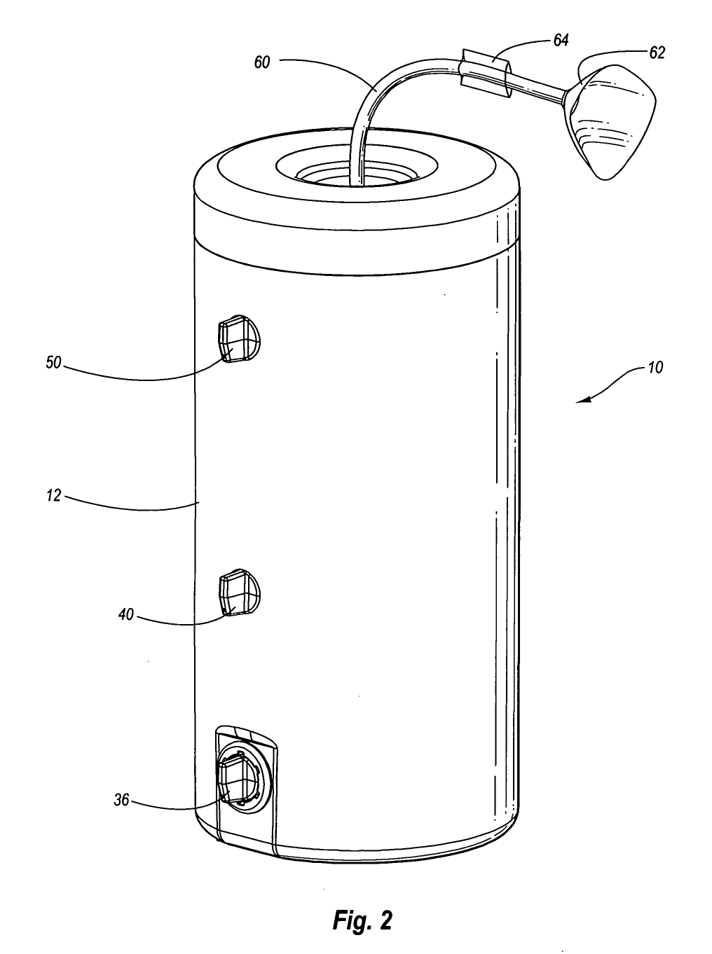

FIGS. 1 and 2 show the oxygen generation system of the invention, which is designated as 10 in the drawings. The oxygen generation system 10 includes a canister body 12 which includes a first reaction chamber 14, a second reaction chamber 16 and a third reaction chamber 18. The first reaction chamber 14 includes a first reactant 20. The second reaction chamber 16 includes a second reactant 22. The third reaction chamber 18 includes a coolant 24. Located within the first reaction chamber 14 is a second catalyst chamber 26. Located within second catalyst chamber 26 is a quantity of chemical known as the second catalyst 28. The oxygen generation system 10 of the invention also includes a first catalyst chamber 30 in which is located a quantity of first catalyst 32.

The oxygen generation system 10 includes a first valve 34 in which the second catalyst chamber and the second catalyst is located. The first valve 34 includes a control knob 36 which extends beyond the exterior of the canister body 12.

The oxygen generation system 10 of the invention also includes a second valve 38. The second valve 38 also includes a control knob 40 which extends beyond the canister body 12 and is accessible from the outside. The control knob 40 is operatively connected to a plate 42. The plate 42 is pressed against one or more sealing members 44 which can be in the form of O rings. The O rings 44 are seated in the base of the second reaction chamber 16. The control knob 40 is configured so that rotation of the control knob 40 causes the plate 42 to move away from its contact with the sealing members 44. When the plate 42 moves away from the second reaction chamber 16, a passageway 46 is opened between the first reaction chamber 14 and the second reaction chamber 16, and the second reactant 22 being a liquid, flows into the first reaction chamber 14. Since the first catalyst chamber 30 is bounded on one side by the plate 42, when the plate 42 opens, the liquid second reactant contacts the first catalyst and flushes it into the first reaction chamber 14.

The system 10 also includes a third valve 48 and a third knob 50 which extends beyond the canister body 12 for easy access. Turning the third knob 50 opens the valve 48 and establishes an escape pathway for oxygen from the second chamber into the third reaction chamber 18. Attached to the third valve 48 is a tube 52 through which generated oxygen passes and is allowed to bubble through the coolant 24. There is a passageway 54 out the top of the canister through which the generated oxygen passes. On the exterior of the canister is located a nipple 56 which is sealed by a threaded stopper 58 when the device is not in use. FIG. 2 shows the exterior of the canister with the first knob 36, second knob 40, third knob 50 and an oxygen delivery system in the form of a flexible tube 60 attached to a facemask 62. A filter 64 is included as part of the oxygen delivery system. Filter 64 may additionally include an inline moisture trap, and contain activated carbon for absorption of non-oxygen gases and contaminants.

The first valve 34 has a housing (located in the first reaction chamber 14) with a built in pressure relief mechanism that will relieve any large pressure build up in the first reaction chamber 14 if the chemical reaction starts (i.e. the unit is activated intentionally or unintentionally) and the second valve 38 or third valve 48 are left closed and/or the threaded stopper 58 in the top of the unit has not been removed.

The first valve housing has a small opening on its end that is located inside the first reaction chamber 14. This small opening allows any gas pressure in the first reaction chamber 14 to push on the inside end of the first valve 34. The first valve 34 is held in place and sealed by several o-rings. Sufficient pressure will cause the first valve 34 to be pushed out to the point where the o-rings no longer seal the valve closed and the pressure can be relieved. The carrying case/storage bag helps shield and redirect the release of this gas pressure.

The top of the carrying case may use a hook and loop closure tab that can be opened to reveal the exit nipple 56 that is sealed with a threaded stopper 58. The threaded stopper 58 has to be removed and a short piece (2.5 foot length) of three-channel oxygen supply tubing 60 is to be connected to the nipple 56. The other end of this tubing is attached to the inlet end of an inline moisture trap/activated carbon filter 64. A length of three-channel oxygen supply tubing with a permanently attached breathing mask may be attached to the outlet end of the inline moisture trap/activated carbon filter.

The third chamber 18 of the generator 10 contains water and is designed to act as a self-contained filter/scrubber for the oxygen that is produced. It also acts as a cooler to keep the temperature of the oxygen within acceptable limits for patient use. It performs these functions by impingement. The third chamber is kept separated from the second chamber 16 of the device by a rotary valve 48 that is only opened when the device is activated for use.

The second chamber of the generator preferably (but not exclusively) stores a liquid second reactant such as hydrogen peroxide. The hydrogen peroxide is kept separated from the other chemicals until the oxygen generation system 10 is activated. The second chamber of the device is kept separate from the first chamber by a plunger valve 38 that is kept closed by a rotary cam shaft. The plunger valve body chamber has a small internal storage area which serves as the first catalyst chamber 30, and holds some of the first catalyst 32 that is used to promote the chemical reaction and produce the oxygen.

The first chamber preferably contains a first reactant that combines with the second reactant to produce oxygen. One possible reactant is granular sodium percarbonate. Other reactants could include sodium carbonate, sodium chlorate, sodium perborate, and sodium perborate tetrahydrate. The first chamber is also the location for a chamber-type valve that serves as the second catalyst chamber 26 and contains a second catalyst. The first chamber acts as the reaction chamber.

The catalyst used may be chosen from a number of known catalysts used in oxygen generating reactions, such as manganese dioxide.

All valves will be in a closed position when the generator is charged, in storage, and ready for use. A wrench may be attached to the carrying case/storage bag by a cord and can be used to assist in turning the valve knobs from the closed to the open position.

The oxygen generation system of the invention is activated by opening the first valve 34. This exposes the second catalyst. The plunger valve 38 is opened next. This allows the hydrogen peroxide to drop into the first chamber while flushing the first catalyst 32 with it. The third valve 48 is then opened immediately. The generated oxygen exits the device 10 by first entering the now empty second chamber 16 where any foam or bubbles break up. It then enters the third chamber 18 where it bubbles through the water for cooling and scrubbing (cleaning) for removal of any possible carryover of the reaction chemicals. It leaves the device through the top nipple 56 and is conveyed by the tubing 60 to the inline moisture trap/activated carbon filter 64 and then on through more tubing to the oxygen mask 62.

The thermoplastic generator's outside diameter can be sized to varying dimensions, and may be approximately 178 mm (7″) and its height may be approximately 15″. The carrying case/storage bag's outside diameter and height is sufficient to contain the generator unit with a loose fit. The carrying case/storage bag also may have an attached zippered pouch for the various kit components.

Oxygen can be generated by various chemical reactions. One preferred reaction, though not the only reaction possible, uses liquid hydrogen peroxide. The chemical reaction can be considered a two phase process. First the liquid hydrogen peroxide reacts with the catalysts to produce oxygen and water and then that water and the sodium percarbonate and catalysts react to produce additional oxygen. The chemical formula for this reaction is as follows:

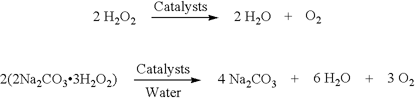

The chemicals in the oxygen generation system consist of water (H₂O) in the third chamber, diluted hydrogen peroxide (H₂O₂) in the second chamber, granular sodium percarbonate (2Nₐ₂CO₃•3H₂O₂) in the first chamber, and two units of catalysts that are stored in the plunger valve storage area (first catalyst chamber 26) and the chamber-type valve. The catalysts promote the generation of oxygen from the hydrogen peroxide and the sodium percarbonate. The reaction is exothermic and therefore heat is generated when the oxygen is produced. By the completion of the reaction, the temperature of the reactant products is close to 90° C. (194° F.). These reactant products remain in the first chamber of the generator after the oxygen is produced. The insulated carrying case/storage bag protects the operator and patient from this heat.

After the reaction is complete which usually takes about 27 to 30 minutes (the generator needs to be allowed to quit bubbling completely), the third knob 50, should be closed by turning the knob ½ turn counterclockwise. The oxygen mask and its tubing, the inline filter, and the short piece of oxygen tubing should be removed and returned to the side pocket. The threaded stopper should be replaced in the exit nipple to seal the generator closed and keep the water and other reaction chemicals within in the generator unit. The oxygen generation system is designed for single use only and should be returned to the manufacturer after being used. In the event that the unit gets disposed of, the contents are not a toxic hazard. They are water, sodium carbonate (soda ash) which is a naturally occurring salt, and the catalysts which occur naturally in the environment as minerals.

The purpose of the oxygen generation system is to generate breathable oxygen from the chemicals contained within the unit.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. An oxygen generation system comprising:
a canister body, the canister body comprising;
a first reaction chamber, with said first reaction chamber containing a first reactant;
a second reaction chamber and said second reaction chamber containing a second reactant for an oxygen generating reaction;
a valve between a first and a second reaction chamber, to allow gravity flow of said second reactant from the second reaction chamber into the first reaction chamber;
a first catalyst chamber, for isolating a first catalyst and for releasing said first catalyst into said first reaction chamber by mixing with said second reactant;
a second catalyst chamber located in said first reaction chamber, for isolating a second catalyst, with said second catalyst chamber sealable to said first reactant and configured for release of said second catalyst to said second reactant;
an escape route for generated oxygen from the first reaction chamber; and
an oxygen delivery system operatively connected to the escape route for delivering oxygen to a user; wherein
said oxygen generation system produces oxygen for use by a user when said valve between said first and said second reaction chambers is opened to allow gravity flow of said second reactant into said first reaction chamber, with said flow of second reactant causing mixing of said first catalyst with said second reactant, with said second reactant further contacting said first reactant and said second catalyst in said second catalyst chamber, with the resultant reaction generating a steady flow of oxygen for a selected time.

2. The oxygen generation system of claim 1 in which said first and second catalyst are different chemicals.

3. The oxygen generation system of claim 1 in which the first and second catalyst each contain more than one chemical.

4. The oxygen generation system of claim 1 in which the valve between the second and first reaction chambers is a plunger type valve.

5. The oxygen generation system of claim 4 the first catalyst chamber is opened by the plunger valve.

6. The oxygen generation system of claim 4 the first catalyst chamber is part of the plunger valve, and said first catalyst is released by opening the plunger valve.

7. The oxygen generation system of claim 1 the second catalyst chamber is configured to expose the second catalyst by turning a shaft.

8. The oxygen generation system of claim 7 in which the shaft is turned by turning a knob.

9. The oxygen generation system of claim 1 which further comprises a third reaction chamber, said third reaction chamber containing a coolant, and a passage to the second reaction chamber.

10. The oxygen generation system of claim 9 in which said coolant is water.

11. The oxygen generation system of claim 9 includes a valve between the second and third reaction chambers.

12. The oxygen generation system of claim 1 second catalyst chamber releases second catalyst by floating out into second reactant when it enters first reaction chamber.

13. The oxygen generation system of claim 9 in which said canister body further comprises three knobs to activate oxygen generation; a knob to expose said second catalyst, a knob to release said second reactant into first reaction chamber, and a knob to open a valve between said second and third reaction chambers.

14. The oxygen generation system of claim 9 in third chamber has a u shaped tube to bubble gas through said coolant.

15. A method of generating oxygen in a portable generator, comprising the steps of:
providing an oxygen generation canister containing a first reaction chamber, with said first reaction chamber containing a first reactant;
the canister including a second reaction chamber and said second reaction chamber containing a second reactant for an oxygen generating reaction;
the canister including a valve between a first and a second reaction chamber, to allow gravity flow of said second reactant from the second reaction chamber into the first reaction chamber;
the canister including a first catalyst chamber, configured to isolate a first catalyst and to release said first catalyst into said first reaction chamber by mixing with said second reactant;
the canister including a second catalyst chamber located in said first reaction chamber, for isolating a second catalyst, with said second catalyst chamber sealable to said first reactant and configured for release of said second catalyst;
the canister including an escape route for generated oxygen from the first reaction chamber;
opening said valve between said first and second reaction chambers to allow gravity flow of said second reactant into said first reaction chamber, with said flow of second reactant causing mixing of said first catalyst with said second reactant, with said second reactant further contacting said first reactant and said second catalyst in said second catalyst chamber, with the resultant reaction generating a steady flow of oxygen for a selected period of time; and
providing an oxygen delivery system operatively connected to said escape route for delivering oxygen to a user.

16. The method of generating oxygen in a portable generator of claim 15 in which said step of providing an oxygen generation canister further includes providing said canister with a first and second catalyst in which said first and second catalyst are different chemicals.

17. The method of generating oxygen in a portable generator of claim 15 in which said step of providing an oxygen generation canister further includes providing said canister with the first and second catalyst each containing more than one chemical.

18. The method of generating oxygen in a portable generator of claim 15 in which said step of providing an oxygen generation canister further includes providing said canister with a plunger type valve between the second and first reaction chamber.

19. The method of generating oxygen in a portable generator of claim 17 in which said step of providing an oxygen generation canister with a plunger valve further includes providing a plunger which opens the first catalyst chamber when the plunger valve is opened.

20. The method of generating oxygen in a portable generator of claim 17 in which said step of providing an oxygen generation canister further includes providing a canister in which said first catalyst is released by opening the plunger valve.

21. The method of generating oxygen in a portable generator of claim 15 in which said step of providing an oxygen generation canister further includes providing said canister which is configured to expose said second catalyst by turning a shaft.

22. The method of generating oxygen in a portable generator of claim 20 in which said step of providing an oxygen generation canister further includes providing said canister in which second catalyst is exposed by turning a shaft and the shaft is turned by use of a knob on the canister.

23. The method of generating oxygen in a portable generator of claim 15 in which said step of providing an oxygen generation canister further includes providing said canister further comprises a third reaction chamber, said third reaction chamber containing a coolant, and a passage to the second reaction chamber.

24. The method of generating oxygen in a portable generator of claim 22 in which said step of providing an oxygen generation canister further includes providing said third reaction chamber of said canister with water as the coolant.

25. The method of generating oxygen in a portable generator of claim 22 in which said step of providing an oxygen generation canister with a third reaction chamber further includes providing a valve between the second and third reaction chambers.

26. The method of generating oxygen in a portable generator of claim 15 in which said step of providing an oxygen generation canister further includes providing said canister with a second catalyst chamber configured to release said second catalyst into said second reactant by floatation of said second catalyst from said second catalyst chamber.

27. The method of generating oxygen in a portable generator of claim 24 in which said step of providing an oxygen generation canister further includes providing said canister with three knobs for activation, with a knob to expose the second catalyst, a knob to release the second reactant into the first reaction chamber, and a knob to open valve between second and third reaction chambers.

28. The method of generating oxygen in a portable generator of claim 22 in which said step of providing an oxygen generation canister further includes providing said third reaction chamber with a U-shaped tube to bubble gas into the coolant.
